(19) United States
(12) Patent Application Publication
(10) Pub. No.: US 2006/0291137 A1
(43) Pub. Date: Dec. 28, 2006

(54) Method for surface treatment of nickel particles with acid solution

(75) Inventors: Yong Kyun Lee, Gyeonggi-Do (KR); Hyun Chul Lee, Ulsan-Si (KR); Seon Mi Yoon, Gyeonggi-Do (KR); Jae Young Choi, Gyeonggi-Do (KR)

Correspondence Address: BUCHANAN, INGERSOLL & ROONEY PC, POST OFFICE BOX 1404, ALEXANDRIA, VA, 22313-1404, US

(73) Assignee: Samsung Electro-mechanics Co., Ltd., Gyeonggi-Do (KR)

(21) Appl. No.: 11/131,306

(22) Filed: May 18, 2005

(30) Foreign Application Priority Data
Dec. 15, 2004 (KR) 2004-106328

(51) Int. Cl. H01G 4/008; B22F 1/00; H01B 1/02

(52) U.S. Cl. 361/303; 148/513; 252/513

(57) ABSTRACT

Disclosed is a method for surface treatment of nickel particles using an acid solution, comprising mixing a weak acid with a buffer solution to prepare an acid solution having a pH of 2 to 5; mixing the acid solution with nickel particles; and filtering, washing and drying the mixed solution. Nickel particles treated by an embodiment of the method of present invention are free of impurities remaining on particle surfaces and thus have smooth surfaces and increased tap density, and use thereof may enable efficient production of a multi-layer ceramic capacitor (MLCC).

### BACKGROUND

This non-provisional application claims priority under 35 U.S.C. §119(a) on Korean Patent Application No. 2004-106328 filed on Dec. 15, 2004, which is herein incorporated by reference.

1. Field of the Invention

An embodiment of the present invention relates to a method for surface treatment of nickel particles using an acid solution. More particularly, an embodiment of the present invention relates to a method for surface treatment of nickel particles using an acid solution, involving mixing an acid solution with nickel particles, followed by filtration, washing and drying to obtain nickel particles having smooth surfaces and increased tap density.

2. Description of the Art

A multi-layer ceramic capacitor (MLCC) is prepared by laminating a multiplicity of dielectric thin film layers and a multiplicity of internal electrodes. The MLCC having such a structure exerts large capacitance even with a small volume and thus is widely used in electronic instruments such as computers and mobile communication instruments, for example.

As materials for internal electrodes of the MLCC, Ag—Pd alloys have been used. Since Ag—Pd alloys can be sintered in the air, they are easily applicable to MLCC manufacturing, but are disadvantageously expensive. As such, in order to reduce MLCC production costs, since the late 1990's, a great deal of efforts have been made to replace Ag—Pd alloys with relatively cheap nickel, as an internal electrode material. Internal nickel electrodes of the MLCC are formed from a conductive paste containing nickel metal particles.

Processes for preparing nickel metal particles are broadly divided into two methods; one is a vapor phase method and the other is a liquid phase method. The vapor phase method is widely used due to the fact that shapes of nickel metal particles and impurities are relatively easily controlled, but is disadvantageous from the standpoints of particle micronization and large-scale production. In contrast, the liquid phase method is advantageous in that large-scale production is easily implemented and initial investment costs and process costs are low.

The liquid phase method may be sub-divided into two types. One is a method using nickel hydroxide as a starting material that is converted into nickel metal particles. The other is a method using nickel precursor materials other than nickel hydroxide, such as nickel salts and nickel oxides, as a starting material that is converted into nickel metal particles.

The first method is advantageous in that the manufacturing process is relatively simple, but also suffers from disadvantages that the starting material, nickel hydroxide, is expensive and controlling particle size of nickel metal particles is not easy.

The second method is disadvantageous due to relatively complex processes, but is advantageous in that inexpensive nickel precursor materials such as nickel sulfate, nickel chloride and nickel acetate may be used as the starting material, and it is relatively easy to control the particle size ranging from several nanometers to several hundreds of nanometers.

As patents relating to the liquid phase method, reference may be made to U.S. Pat. Nos. 4,539,041 and 6,120,576.

U.S. Pat. No. 4,539,041 proposes a method of obtaining metal powder, involving dispersing gold, palladium, platinum, iridium, osmium, copper, silver, nickel, cobalt, lead and cadmium in the form of an oxide, hydroxide or salt thereof, in a liquid polyol as a reducing agent and thereafter heating them.

U.S. Pat. No. 6,120,576 proposes a method for preparing nickel metal powder comprising the steps of mixing an aqueous sodium hydroxide solution with an aqueous solution of nickel sulfate to form nickel hydroxide; reducing the resulting nickel hydroxide with hydrazine to produce nickel; and recovering nickel thus produced.

In the above-mentioned methods, an alkali is added in order to effect conversion of the nickel precursor compound into nickel hydroxide. As the alkali added, sodium hydroxide, potassium hydroxide or the like is conventionally used. In this case, impurities such as sodium, potassium and the like remain on the surface of nickel metal powder. Alkali metals such as sodium and potassium have very low surface energy, and thus it is very difficult to remove them from nickel metal powder.

Preferably, nickel metal powder for use in a high-capacitance MLCC should have highly improved electrical conductivity, contain least content of impurities adversely affecting electric capacity of a dielectric and have high tap density. In particular, nickel metal particles obtained by liquid phase chemistry pose problems in that it is very difficult to remove hydroxides produced on surfaces of nickel metal particles in a manufacturing process.

US Patent Publication No. 2003-0220221 discloses a method, composition and kit for treating and/or cleaning surfaces, involving treatment of surfaces of metal particles with a solution of a monoacid comprising at least one nitrogen atom, in order to remove impurities on surfaces of metal particles. However, since this method primarily uses only a solution of an acid containing nitrogen atoms while having a relatively large molecular weight, pH of the solution varies causing the reaction rate to slow, thereby resulting in a problem of coating on the surface of nickel particles, with the passage of time.

### SUMMARY

An embodiment of the present invention has been made in view of the above problems, and it is an object of the present invention to provide nickel particles having smooth surfaces and increased tap density, by treating nickel particles with a mixed solution of a weak acid and a buffer solution to remove impurities on surfaces of nickel particles, while maintaining original shape thereof.

In accordance with an aspect of the present invention, the above and other objects can be accomplished by the provision of a method for surface treatment of nickel particles using an acid solution, comprising mixing a weak acid with a buffer solution to prepare an acid solution having a pH of 2 to 5; mixing the acid solution with nickel particles; and filtering, washing and drying the mixed solution.

In accordance with another aspect of the present invention, nickel particles surface-treated by the above-mentioned method are provided.

In accordance with yet another aspect of the present invention, there is provided a conductive paste comprising nickel particles thus treated.

In accordance with still another aspect of the present invention, there is provided a multi-layer ceramic capacitor (MLCC), nickel internal electrodes of which contain the thus-treated nickel particles.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an SEM of the surface of nickel particles having rough surface obtained by a conventional liquid phase reduction method;

FIG. 2 is a schematic process flow diagram of surface treatment using an acid solution in accordance with an embodiment of the present invention;

FIG. 3a is a graph showing constant pH of an acid solution maintained by a buffer solution;

FIG. 3b is a graph showing rate of change in pH of an acid solution with respect to the passage of time, in the absence of a buffer solution;

FIG. 4 schematically shows one embodiment of MLCC in accordance with the present invention;

FIG. 5 is an SEM of surface-treated nickel particles obtained in Example 1 of the present invention;

FIG. 6 is a graph showing XPS analytical results after sputtering of surface-treated nickel particles obtained in Examples 1 of the present invention;

FIG. 7 is an SEM of surface-treated nickel particles obtained in Comparative Example 1 of the present invention;

FIG. 8 is an SEM of surface-treated nickel particles obtained in Comparative Example 2 of the present invention;

FIG. 9 is an SEM of surface-treated nickel particles obtained in Comparative Example 3 of the present invention; and

FIG. 10 is an SEM of surface-treated nickel particles obtained in Comparative Example 4 of the present invention.

### DESCRIPTION OF THE EXEMPLARY EMBODIMENTS

Now, the present invention will be described in more detail with reference to accompanying drawings.

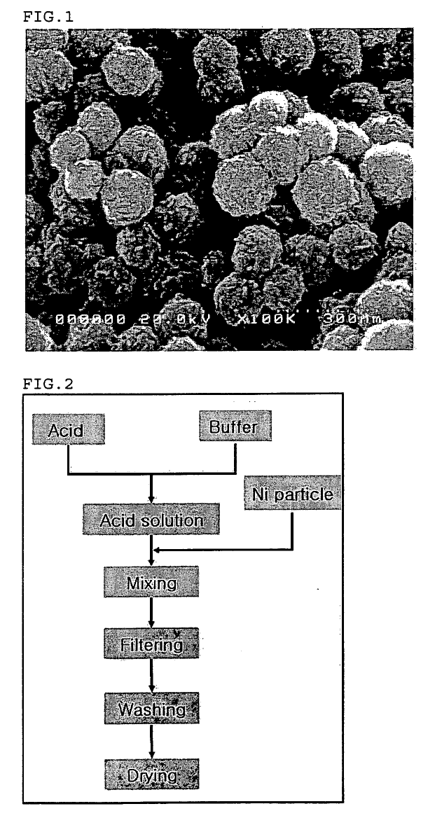

FIG. 1 is an SEM of nickel particles obtained by a conventional liquid phase reduction method. As can be seen, nickel particles obtained by the liquid phase reduction method have rough surfaces due to Ni(OH)₂ or Ni₂O₃ grown or produced on their surfaces. Now, a process of removing such impurities will be described in more detail, through a surface treatment process in accordance with the present invention schematically shown in FIG. 2.

In the method for surface treatment of nickel particles in accordance with the present invention, the first step may include mixing a weak acid with a buffer solution so as to prepare an acid solution having an appropriate pH range.

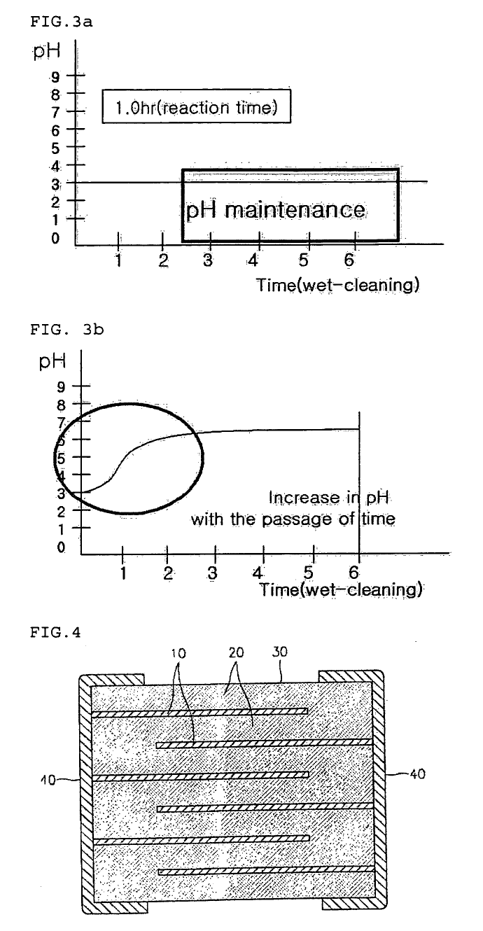

As used herein, the term “acid solution” refers to a solution in which a weak acid is mixed with a buffer solution in water as a solvent. As shown in FIG. 3a, the acid solution in accordance with the present invention may be characterized by having a constant pH at a certain value within the range of pH 2 to 5, despite the passage of time. That is, in the acid solution having a constant pH, impurities may be removed in such a manner that hydrates on surfaces of nickel particles are dissociated to ionic state by reaction with the acid solution. Where the buffer solution is not present, as shown in FIG. 3b, the pH of the solution varies with progress of the surface treatment reaction, which in turn, may cause delay of the reaction rate, entailing a problem associated with adsorption of molecules in the solution onto surfaces of nickel particles. Therefore, in order to keep the pH of the solution at a constant value, the acid solution in accordance with the present invention should be composed of a mixture of a weak acid and buffer solution. In addition, where the buffer solution is not included, a relatively large amount of acid may be required and thus, from the cost standpoint, combined use of the acid and buffer solution may be preferred to carry out the surface treatment process. Further, in order to maintain the degree of constant surface treatment with respect to the passage of time, it may be necessary to maintain acidity of the acid solution, which may be used in the present invention, within the range of pH 2 to 5, using the buffer solution.

Weak acids are only used in preparation of the acid solution in accordance with the present invention. This is because a strong acid such as HCl or HF is strongly reactive and thus may cause holes on the surface of nickel particles.

Although there is no particular limit to kinds of weak acids that can be used in the present invention, mention may be preferably made of a monoacid represented by the general formula of RCOOH wherein R is H, CH₃, CH₂CH₃ or (CH₂)₂CH₃. Preferably, organic acids containing 1 to 6 carbon atoms may be used to effectively achieve desired effects of the present invention.

In addition, buffer solutions, which may be utilized in preparing the acid solution of the present invention, include, but are not limited to, for example NaCl, carbonic acid, phosphoric acid and mixtures thereof. There is no particular limit to the amount of the buffer solution used. More preferably, the buffer solution may be used in the range of 1:1 to 20:1, in terms of conjugate acid-base ratio relative to acid to be used.

The second step in the method for surface treatment of nickel particles in accordance with the present invention may include mixing the thus-prepared acid solution with nickel particles that are desired to be surface-treated. There is no particular limit to the amount of the acid solution used, but a greater amount of acid than impurities to be treated may be used, if possible, in order to accomplish desired effects of the present invention. More preferably, a mixing ratio of the acid solution and nickel particles in the range of 20:1 to 500:1 can be used to carry out surface treatment of nickel particles.

The temperature for carrying out surface treatment after the mixing step is not particularly limited, but surface treatment may be performed at room temperature.

The present method may be carried out using any open reaction vessel or closed reaction vessel.

The third step in the method for surface treatment of nickel particles in accordance with the present invention may include filtering, washing and drying the mixed solution.

Solvents utilized in washing the mixed solution are not particularly limited, so long as they are conventionally used in the art. For example, mention may be made of acetone and ethanol.

Although drying may be carried out in conventional atmosphere, it may be performed at room temperature under vacuum.

In another aspect, the present invention provides nickel particles, surface impurities of which may be removed by using the above-mentioned method. Although there is no particular limit to particle size, it may be in the range of several nanometers to several micrometers. Nickel particles in accordance with the present invention can be utilized in various applications such as internal wiring materials of electronic circuits, catalysts and the like. In particular, nickel particles in accordance with the present invention may be free of surface impurities and have high tap density, and thus they may be very suitable as materials for internal electrodes of MLCC.

In yet another aspect, the present invention provides a conductive paste comprising the thus surface-treated nickel particles, an organic binder and an organic solvent. As the organic binder, for example, ethylcellulose or the like may be used. As the organic solvent, mention may be made of terpineol, dihydroxy terpineol, 1-octanol and kerosene, as examples. In the conductive paste in accordance with the present invention, the content of the nickel particles may be about 40% by weight, the content of the organic binder may be about 15% by weight and the content of the organic solvent may be about 45% by weight, for example. However, without being limited to the above-mentioned ranges, the composition ratio of the respective components may vary depending upon desired uses. In addition, the conductive paste in accordance with the present invention may further comprise, for example additives such as a plasticizer, an anti-thickening agent and a dispersant. A variety of well-known methods may be employed to prepare the conductive paste in accordance with the present invention.

In still another aspect, the present invention may provide a multi-layer ceramic capacitor (MLCC), internal electrodes of which contain the thus-treated nickel particles.

One embodiment of the MLCC in accordance with the present invention is shown in FIG. 4. The MLCC of FIG. 4 may be made up of a laminate 30 consisting of internal electrodes 10 and dielectric layers 20, and terminal electrodes 40. The internal electrodes 10 are formed such that either of their end most parts are exposed to either of the corresponding surfaces of the laminate 30 in order to effect contact between internal electrodes 10 and terminal electrodes 40.

As an example, the MLCC in accordance with the present invention may be prepared as follows. A paste for forming dielectric layers containing dielectric materials and the conductive paste in accordance with the present invention may be alternately printed and the resulting laminate may be fired. The conductive past may be applied to the cross-sections of the laminate 30, in order to effect electrical and mechanical conjugation between the cross-sections of the fired laminate 30 and end most parts of the internal electrodes 10 exposed thereto, followed by firing to form terminal electrodes 40. The MLCC in accordance with the present invention is not limited to the embodiment shown in FIG. 4, and may have a variety of shapes, dimensions, lamination and circuit configurations.

### EXAMPLES

Now, the present invention will be described in more detail with reference to the following Examples. These examples are provided only for illustrating the present invention and should not be construed as limiting the scope and spirit of the present invention.

### Example 1

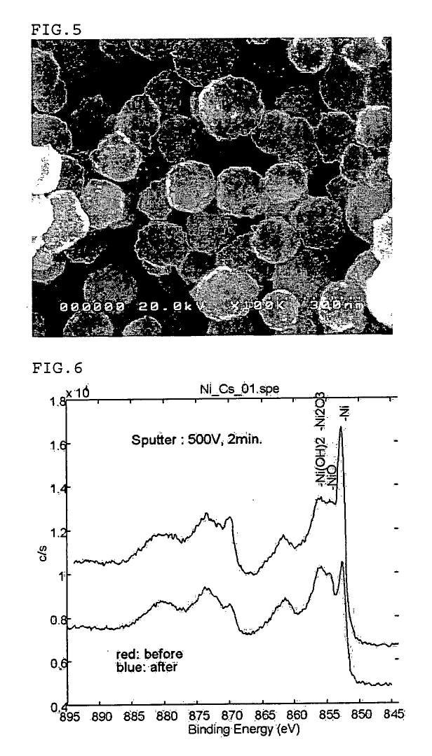

250 g of water, 1.24 g of 0.2M CH₃COOH and 200 ml of 0.2M NaCl were mixed with stirring so as to prepare an acid solution having a pH of 2.68, using a pH meter (available from SCHOTT-DURAN). The prepared acid solution was mixed with 2 g of nickel, prepared using a liquid phase method, and the resulting mixture was charged and stirred in a flask. The mixture contained in the flask was stirred for 1 hour using a magnetic stirrer, so as to produce nickel metal powder having a smooth surface. The resulting nickel metal powder was filtered, separated and washed with acetone and ethanol. The thus-obtained nickel metal powder was dried in a vacuum overnight at a temperature of 25° C. An SEM of nickel particles thus obtained is shown in FIG. 5. As can be confirmed in FIG. 5, nickel particles surface-treated by the method of present invention are free of impurities remaining on particle surfaces and thus have smooth surfaces. Upon tapping nickel particles 1000 times, the tap density of particles before surface treatment was 1.4300 g/ml, while the tap density of particles after surface treatment was determined to be 1.5163 g/ml. After sputtering the nickel particles thus obtained, X-ray Photoelectron Spectroscopy (XPS) analytical results of nickel particles are shown in FIG. 6 and atomic concentration data is shown in table 1 below, respectively. As can be confirmed from the XPS results, large amounts of surface Ni₂O₃ or Ni(OH)₂ were removed and the nickel content was relatively increased.

TABLE 1

| | C1s[0.314] | O1s[0.733] | Ni2p |
|---|---|---|---|
| Before acid solution treatment | 6.51 | 33.68 | 59.81 |
| After acid solution treatment | 6.85 | 29.73 | 63.42 |

### Comparative Example 1

Using a pH meter (available from SCHOTT-DURAN), 1200 ml of 0.2M HCl was stirred to prepare an acid solution having a pH of 0.69. The prepared acid solution was mixed with 2 g of nickel, prepared using a liquid phase method, and the resulting mixture was charged and stirred in a flask. The mixture contained in the flask was stirred for 1 0hour using a magnetic stirrer, so as to produce surface-treated nickel metal powder. The resulting nickel metal powder was filtered, separated and washed with acetone and ethanol. The thus-obtained nickel metal powder was dried in a vacuum overnight at a temperature of 25° C. An SEM of nickel particles thus obtained is shown in FIG. 7. As can be confirmed in FIG. 7, there was observed holes formed on surfaces of nickel particles due to use of HCl.

### Comparative Example 2

536 ml of 0.2M HCl and 200 ml of 0.2M NaCl were mixed with stirring so as to prepare an acid solution having a pH of 1.23, using a pH meter (available from SCHOTT-DURAN). The prepared acid solution was mixed with 2 g of nickel, prepared using a liquid phase method, and the resulting mixture was charged and stirred in a flask. The mixture contained in the flask was stirred for 1 hour using a magnetic stirrer, so as to produce surface-treated nickel metal powder. The resulting nickel metal powder was filtered, separated and washed with acetone and ethanol. The thus-obtained nickel metal powder was dried in a vacuum overnight at a temperature of 25° C. An SEM of nickel particles thus obtained is shown in FIG. 8. As can be confirmed in FIG. 8, nickel particles exhibited rough surfaces and holes.

### Comparative Example 3

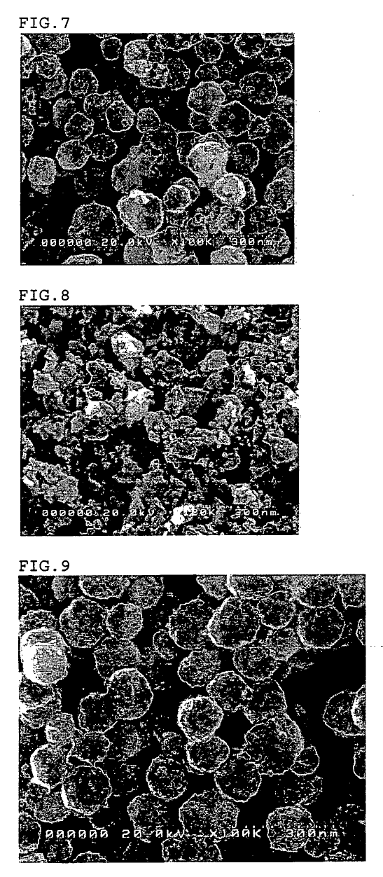

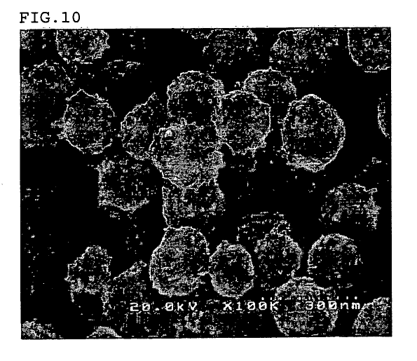

500 ml of 0.2M CH₃COOH and 200 ml of acetone were mixed with stirring so as to prepare an acid solution having a pH of 1.13, using a pH meter (available from SCHOTT-DURAN). The prepared acid solution was mixed with 2 g of nickel, prepared using a liquid phase method, and the resulting mixture was charged and stirred in a flask. The mixture contained in the flask was stirred for 1 hour using a magnetic stirrer, so as to produce surface-treated nickel metal powder. The resulting nickel metal powder was filtered, separated and washed with acetone and ethanol. The thus-obtained nickel metal powder was dried in a vacuum overnight at a temperature of 25° C. An SEM of nickel particles thus obtained is shown in FIG. 9. As can be confirmed in FIG. 9, there was observed little improvement of surface morphology of nickel particles.

### Comparative Example 4

250 g of water, 1.24 g of acetic acid and 200 ml of 0.2M NaCl were mixed with stirring so as to prepare an acid solution having a pH of 6, using a pH meter (available from SCHOTT-DURAN). The prepared acid solution was mixed with 2 g of nickel, prepared using a liquid phase method, and the resulting mixture was charged and stirred in a flask. The mixture contained in the flask was stirred for 1 hour using a magnetic stirrer, so as to produce surface-treated nickel metal powder. The resulting nickel metal powder was filtered, separated and washed with acetone and ethanol. The thus-obtained nickel metal powder was dried in a vacuum overnight at a temperature of 25° C. An SEM of nickel particles thus obtained is shown in FIG. 10.

As described above, use of the method of the present invention in surface treatment of nickel particles may enable removal of impurities remaining on surfaces thereof at a constant rate within a relatively short period of time through a simplified treatment process, thereby yielding nickel particles having smooth surfaces and increased tap density.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for surface treatment of nickel particles using an acid solution, comprising:
mixing a weak acid with a buffer solution to prepare an acid solution having a pH of 2 to 5;
mixing the acid solution with nickel particles; and
filtering, washing and drying the mixed solution.

2. The method according to claim 1, wherein the weak acid is an organic acid containing 1 to 6 carbon atoms.

3. The method according to claim 1, wherein the buffer solution contains Na⁺ ions or Cl⁻ ions.

4. The method according to claim 1, wherein the mixing ratio of the acid solution and nickel particles is within the range of 20:1 to 500:1.

5. Nickel particles surface-treated by the method of claim 1.

6. A conductive paste comprising nickel particles of claim 5.

7. A multi-layer ceramic capacitor (MLCC) prepared by using nickel particles of claim 5.

8. Nickel particles surface-treated by the method of claim 2.

9. A conductive paste comprising nickel particles of claim 8.

10. A multi-layer ceramic capacitor (MLCC) prepared by using nickel particles of claim 8.

11. Nickel particles surface-treated by the method of claim 3.

12. A conductive paste comprising nickel particles of claim 11.

13. A multi-layer ceramic capacitor (MLCC) prepared by using nickel particles of claim 11.

14. Nickel particles surface-treated by the method of claim 4.

15. A conductive paste comprising nickel particles of claim 14.

16. A multi-layer ceramic capacitor (MLCC) prepared by using nickel particles of claim 14.
